(19) United States
(12) Patent Application Publication
(10) Pub. No.: US 2005/0094362 A1
(43) Pub. Date: May 5, 2005

(54) Mountable display screen filter system

(76) Inventor: John D. Stephens, St. Paul, MN (US)

Correspondence Address: 3M INNOVATIVE PROPERTIES COMPANY, PO BOX 33427, ST. PAUL, MN, 55133-3427, US

(21) Appl. No.: 10/696,941

(22) Filed: Oct. 30, 2003

(51) Int. Cl. G06F 1/16

(52) U.S. Cl. 361/681

(57) ABSTRACT

This disclosure is directed to mountable after-market display screen filter systems that allow repeated removal and remounting of the display screen filters. Specifically, a mountable display screen filter system includes a display screen filter and an adhesive hinge and a clasp to mount a display screen filter to a computer display screen of a computer. The adhesive hinge attaches a first side of the display screen filter to a housing of the computer display screen in a hinged manner. The clasp adheres to the housing and holds a second side of the display screen filter adjacent to the housing without adhering to the display screen filter. A user may operate the clasp to release the display screen filter, allowing the filter to move in an arc about the adhesive hinge.

### FIELD

This disclosure relates to display screen filters, and more particularily to after-market filters for computer display screens.

### BACKGROUND

Display screen filters refer to translucent, partially translucent, or transparent substrates that can be mounted over computer display screens to filter or protect the display screen. In particular, display screen filters can protect the computer screen from scratches, dirt, and fingerprints. In some cases, the display screen filter alters computer screen emissions. Exemplary display screen filters include clear protection filters, anti-glare filters, ultraviolet radiation filters, contrast enhancement filters, polarization filters, radiation and static reduction filters, privacy filters, anti-reflection filters, and numerous other types of filters.

Display screen filters accommodate a variety of computer screen styles and user preferences. For example, display screen filters may be included within a frame that wraps around the sides and top of a desktop monitor. Framed display screen filters may also hang over the computer screen via hanger arms that attach the frame to the top of the desktop monitor.

Frameless display screen filters have also been designed for both desktop monitors and notebook displays. In that case, adhesive tabs typically attach the filter adjacent the computer screen. Double-adhesive stickers have also been used to mount frameless display screen filters directly onto the computer screen.

The mounting techniques used to mount a frameless display screen filter typically attempt to balance aesthetics with usability. For example, a user may mount the frameless filter over a notebook display using a double-stick adhesive. The double-stick adhesive creates a tight bond between the computer screen and the frameless filter, and the adhesive may be invisible so that the adhesive does not disrupt the original aesthetics of the notebook. However, display screen filters are often removed for cleaning and, in the case of privacy filters, information sharing. Once the user removes the frameless filter from the computer screen, the adhesive stickers can lose structural integrity. In particular, double-stick adhesives do not maintain the same bond quality when the user remounts the display screen filter over the computer screen. Many of the problems associated with the existing display screen filter mounting systems arise from the need to repeatedly remove and reattach the display screen filter.

### SUMMARY

In one embodiment, this disclosure provides a mountable display screen filter system that includes a display screen filter, an adhesive hinge to adhere to a housing of a display screen and a first side of the display screen filter such that the first side of the display screen filter is attached to the housing in a hinged manner, and a clasp to adhere to the housing and hold a second side of the display screen filter adjacent the housing without adhering to the display screen filter.

In another embodiment, this disclosure provides a system comprising a computer display including a housing and a display screen viewable through an opening in the housing, and a display screen filter mounted on the housing over the display screen. The display screen filter is mounted via an adhesive hinge that adheres to the housing and a first side of the display screen filter such that the first side of the display screen filter is attached to the housing in a hinged manner. A clasp adheres to the housing and holds a second side of the display screen filter adjacent the housing without adhering to the display screen filter.

In another embodiment, this disclosure provides a method that includes aligning a display screen filter relative to a computer display, the computer display including a housing and a display screen viewable through an opening in the housing, adhering an adhesive hinge to the housing and a first side of the display screen filter such that the first side of the display screen filter is attached to the housing in a hinged manner, and adhering a clasp to the housing to hold a second side of the display screen filter adjacent the housing without adhering the clasp to the display screen filter.

Additional details of these and other embodiments are set forth in the accompanying drawings and the description below. Other features, objects and advantages will become apparent from the description and drawings, and from the claims.

### BRIEF DESCRIPTION OF DRAWINGS

FIG. 1 is a perspective view of a computer utilizing a mountable display screen filter system according to an embodiment of this disclosure.

FIGS. 2A and 2B are schematic diagrams illustrating a front view of the mountable display screen filter system of FIG. 1 with the display screen filter held and released by a clasp.

FIGS. 3A and 3B are schematic diagrams illustrating a cross-sectional side view of the mountable display screen filter system of FIG. 1 with the display screen filter held and released by a clasp.

FIGS. 4A and 4B are schematic diagrams illustrating a front view and a back view of an exemplary adhesive hinge that may be used in a mountable display screen filter system.

FIGS. 5A and 5B are schematic diagrams respectively illustrating a back view and a side view of an exemplary clasp that may be used in a mountable display screen filter system.

FIGS. 6A, 6B, and 6C are schematic diagrams respectively illustrating two front views and a side view of another exemplary clasp that may be used in a mountable display screen filter system.

FIGS. 7A and 7B are schematic diagrams respectively illustrating a front view and a side view of another exemplary clasp that may be used in a mountable display screen filter system.

FIGS. 8A and 8B are schematic diagrams illustrating a front view of an exemplary mountable display screen filter system according to an embodiment of this disclosure.

FIG. 9A and 9B are schematic diagrams illustrating a cross-sectional side view of an exemplary mountable display screen filter system.

FIG. 10 is a flow diagram illustrating a method for mounting a display screen filter over a display screen.

### DETAILED DESCRIPTION

In general, this disclosure is directed to a mountable display screen systems for after-market display screen filters that allow repeated removal and remounting of the display screen filters. Specifically, the mountable display screen system includes a display screen filter, and an adhesive hinge and a clasp to mount the display screen filter to a computer display screen of a computer, such as a desktop, notebook or handheld computer. The adhesive hinge attaches a first side of the display screen filter to a housing of the computer display screen in a hinged manner. The clasp adheres to the housing and holds a second side of the display screen filter adjacent to the housing without adhering to the display screen filter. A user may operate the clasp to release the display screen filter, allowing the filter to move in an arc about the adhesive hinge. In that way, the user can move the display screen filter off of the computer display screen without removing the filter from the housing. Moreover the adhesive hinge remains attached to both the filter and the housing. Therefore, the user may remove and replace the display screen filter repeatedly, without significantly weakening the mounting system.

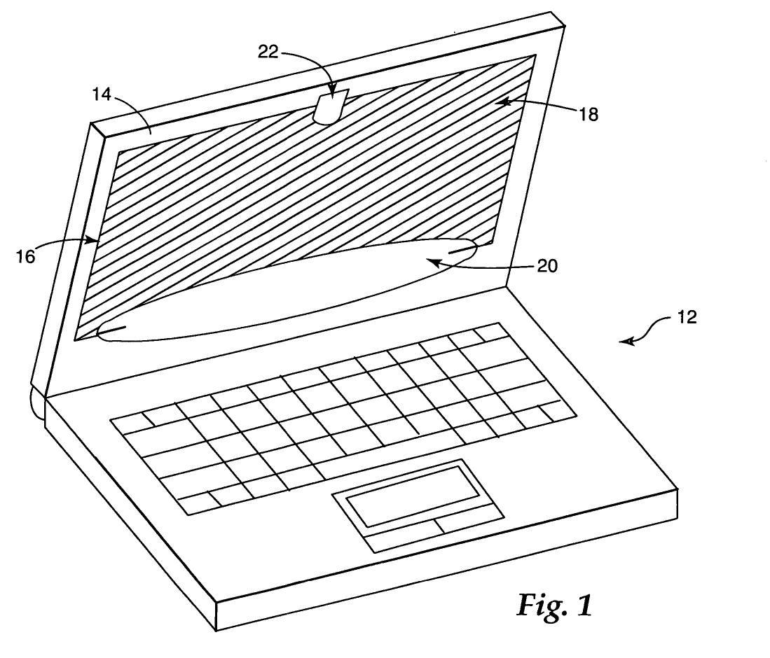

FIG. 1 is a perspective view of a computer 12 utilizing a mountable display screen system including an adhesive hinge 20 and a clasp 22 to mount display screen filter 18 over display screen 16. In this manner, display screen filter 18 mounts onto computer 12. In FIG. 1, computer 12 is a notebook computer, but in other embodiments, computer 12 may be a desktop computer, workstation, laptop or handheld computer that includes a cathode ray tube, liquid crystal display, flat-panel display, plasma display, or any other computer display that may benefit from a filter. Computer 12 includes a housing 14 and a display screen 16. Display screen filter 18 protects display screen 16 from dirt and scratches and may also provide anti-glare functionality, contrast enhancement, polarization effects, radiation or static reduction, ultraviolet radiation reduction, privacy functionality, anti-reflection functionality, or any other desired filtering affect.

Adhesive hinge 20 adheres to a first side of display screen filter 18 and attaches filter 18 to housing 14 in a hinged manner. Clasp 22 adheres to housing 14 such that clasp 22 holds a second side of display screen filter 18 adjacent to housing 14 without adhering to filter 18. A user operates clasp 22 to hold or release filter 18. When released, filter 18 moves in an arc about adhesive hinge 20 to allow the user to view display screen 16 without display screen filter 18. When held adjacent display screen 16 by clasp 22, filter 18 may alter light emissions from display screen 16 to increase viewing comfort, block emitted radiation, or possibly protect confidential screen views from in-direct viewing. In some cases, however, filter 18 may be completely transparent, thus providing protection to display screen 16 without substantially altering the display output.

FIG. 1 shows adhesive hinge 20 and clasp 22 disposed opposite each other on a bottom edge and a top edge of housing 14 respectively. In some embodiments, however, adhesive hinge 20 and clasp 22 may be disposed adjacent to one another or on a left edge or a right edge of housing 14. In further embodiments, a user may apply a plurality of clasps 22 to housing 14 to hold display screen filter 18 over display screen 16.

Adhesive hinge 20 comprises a substrate with a layer of adhesive applied over one side of the substrate. The substrate may be a thin, rigid material such as plastic or metal that resists tearing and pealing. The substrate may be flexible or creased to improve operation as a hinge. The adhesive may be a pressure-adhesive that forms a lasting adhesive bond when pressed onto filter 18 and housing 14. As illustrated in FIG. 1, adhesive hinge 20 has a long, elliptical shape, but in other embodiments, adhesive hinge 20 may assume any shape that secures the first side of display screen filter 18 to housing 14 while minimally disrupting the appearance of computer 12.

Clasp 22 comprises a substantially rigid member with an adhesive layer applied to a first portion of clasp 22 and no adhesive on a second portion. The member may be “memory” material, such as plastic or metal that can be deflected, but returns to its original shape following deflection. The first portion of clasp 22 adheres to housing 14 in such a way that the second portion hangs over display screen 16 to hold the second side of filter 18 adjacent housing 14. As shown in FIG. 1, clasp 22 is a single member, but in other embodiments clasp 22 may comprise two or more members to create a swivel clasp, a hook clasp, or other multi-member clasp to hold filter 18 over display screen 16.

Display screen filter 18 is a frameless display screen filter that fits against display screen 16. For aesthetic purposes, the frameless design substantially maintains the original appearance of computer 12. The frameless design also allows filter 18 to remain on notebook computer 12 at all times, and allows notebook computer 12 to be opened and closed without affecting filter 18.

Conventional frameless filter mounting systems typically mount a filter over a display screen without adding bulk to the frameless design or covering speakers and monitor controls. However, the conventional mounting systems can make the filter difficult to remove and remount without weakening the attachment.

In accordance with this disclosure, adhesive hinge 20 allows a user to remove filter 18 from display screen 16 without removing filter 18 from adhesive hinge 20, or removing adhesive hinge 20 or clasp 22 from housing 14. In that way, display screen filter 18 can be securely mounted to housing 14 adjacent screen 16 via adhesive hinge 20 and clasp 22, yet moved relative to screen 16 without becoming un-attached from housing 14 at adhesive hinge 20. The described mountable display screen filter system also maintains the appearance of computer 12 and adds little extra bulk to housing 14.

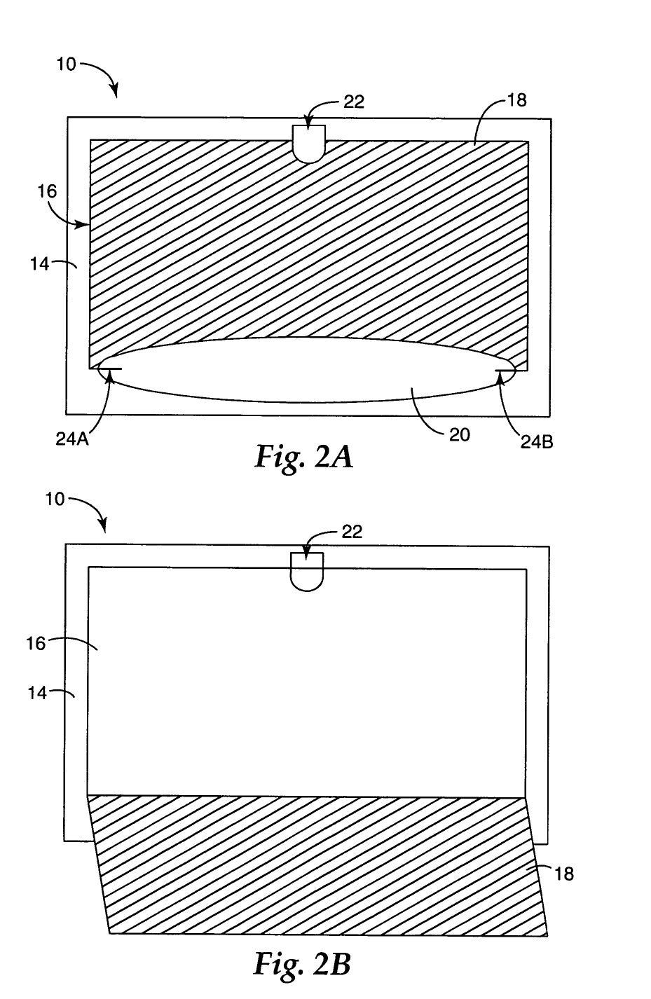

FIGS. 2A and 2B are schematic diagrams illustrating a front view of a mountable display screen system 10 similar to that illustrated in FIG. 1. In particular, system 10 includes a display screen filter 18, an adhesive hinge 20 and a clasp 22. Display screen filter 18 is mounted to housing 14 of display screen 16 by adhesive hinge 20 and clasp 22. Optionally, adhesive hinge 20 may include alignment marks 24A and 24B (hereinafter “alignment marks 24”) printed on adhesive hinge 20 along a major axis of adhesive hinge 20 to allow a user to properly align display screen filter 18 relative to housing 14.

FIG. 2A shows display screen filter 18 held by clasp 22. As described above, adhesive hinge 20 attaches the first side of display screen filter 18 to the bottom edge of housing 14, and clasp 22 adheres to the top edge of housing 14 to hold the second side of filter 18 adjacent housing 14. Alignment marks 24 on adhesive hinge 20 align with an edge of the first side of filter 18. Alignment marks 24 may line up with a bezel of housing 14, where housing 14 and display screen 16 meet. Alignment marks 24 can allow a user to center adhesive hinge 20 between housing 14 and filter 18 in order to ensure the major axis of adhesive hinge 20 acts as the hinge for display screen filter 18.

Clasp 22 may comprise a single member with adhesive on a first portion of the member. Clasp 22 adheres to the top edge of housing 14 by the adhesive layer applied to the first portion of clasp 22. A second portion of clasp 22 has no adhesive layer, such that clasp 22 does not adhere to display screen filter 18. A user may operate clasp 22 to hold or release display screen filter 18 by slightly bending the second portion of clasp 22 to maneuver display screen filter 18 either under or over the second portion of clasp 22. In other embodiments, however, a clasp may comprise two or more members, allowing the user to manipulate the first member with respect to the second member to hold or release filter 18.

FIG. 2B shows display screen filter 18 released from clasp 22 and moved in an arc about adhesive hinge 20. Filter 18 leans out from display screen 16 to allow a user to clean display screen 16 and the side of filter 18 adjacent to display screen 16. In the case where filter 18 is a privacy filter, which inhibits viewing of display screen 16 from non-direct viewing angels, the user may remove filter 18 from display screen 16 to share information displayed on display screen 16 with several people. Such removal of filter 18 from display screen 16 without removing filter 18 from attachment via hinge 20 can be very useful if computer 12 is used for presentations, or the like.

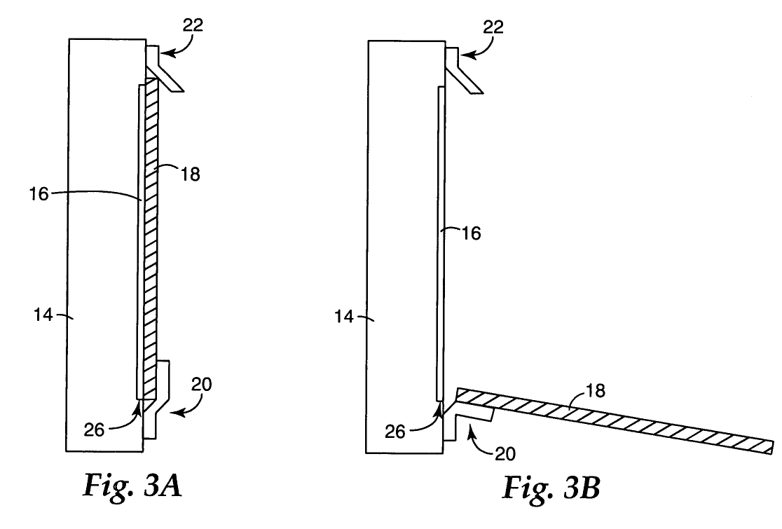

FIGS. 3A and 3B are schematic diagrams illustrating a cross-sectional side view of a mountable display screen system with a display screen filter 18 held and released by clasp 22. Again, the mountable display screen system includes display screen filter 18, adhesive hinge 20, and clasp 22. Adhesive hinge 20 attaches display screen filter 18 to housing 14, and clasp 22 holds filter 18 over display screen 16.

FIG. 3A shows display screen filter 18 held over display screen 16 by clasp 22 in a manner similar to the illustration of FIG. 2A. Adhesive hinge 20 aligns filter 18 relative to housing 14 by aligning a major axis of adhesive hinge 20 along a bezel 26 of housing 14. Bezel 26 comprises an edge of housing 14 around display screen 16. In the embodiment illustrated in FIGS. 3A and 3B, bezel 26 is substantially flat and adhesive hinge 20 wraps around the first side of display screen filter 18 to attach filter 18 to housing 14. In other embodiments, however, a bezel may be wide enough to allow display screen filter 18 to fit adjacent display screen 16 and flush with housing 14. In that case, adhesive hinge 20 would lie flat between filter 18 and housing 14. As shown in FIGS. 3A and 3B, the portion of clasp 22 that holds filter 18 over display screen 16 may bend outward slightly, after the user repeatedly operates clasp 22 to hold or release display screen filter 18.

FIG. 3B shows display screen filter 18 released from clasp 22 and moved in an arc about adhesive hinge 20. Adhesive hinge 20 bends to allow filter 18 to lean out from display screen 16. In some cases, adhesive hinge 20 may limit the range of movement of filter 18. If desired, a crease (not shown) along the major axis of adhesive hinge 18 may increase the flexibility of hinge 20.

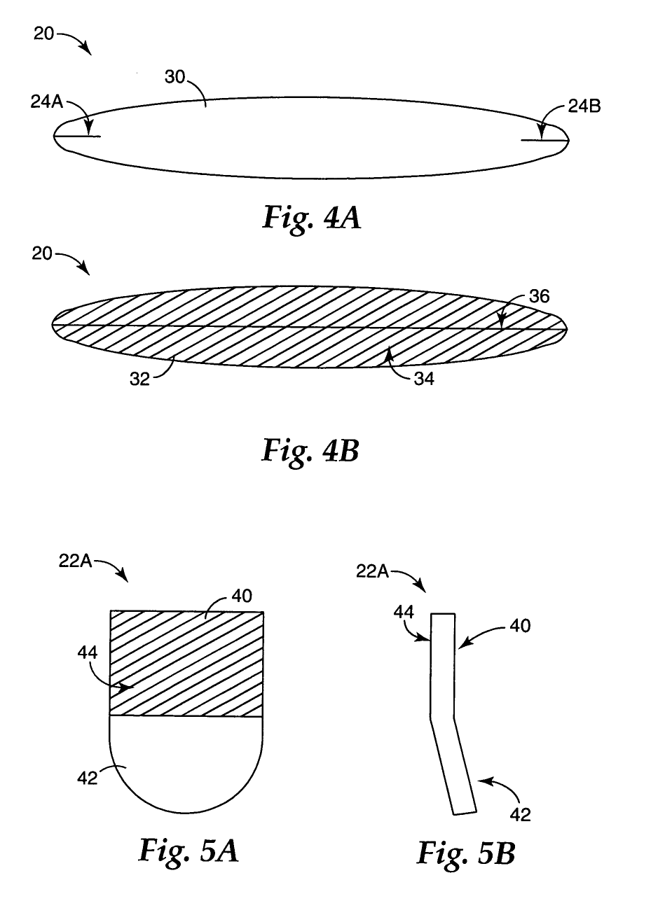

FIGS. 4A and 4B are schematic diagrams illustrating a front view and a back view of adhesive hinge 20. Adhesive hinge 20 comprises a substrate such as plastic or metal and includes a front side 30 and a back side 32 with a layer of adhesive 34 applied to back side 32. Alignment marks 24 from FIG. 2A are printed on front side 30 to aid a user in aligning display screen filter 18 relative to housing 14 as discussed in reference to FIG. 2A. Adhesive hinge 20 also includes crease 36 along a major axis of back side 32, which increases flexibility of the substrate.

Adhesive hinge 20 may have additional markings (not shown), in addition to, or instead of alignment marks 24, e.g., printed on front side 30. The markings may include a source identifier of the manufacturer of adhesive hinge 20, i.e., a trademark. The markings may also include colors and patterns to decorate adhesive hinge 20. Adhesive hinge 20 may be optically clear or translucent so as to not obstruct any portion of display screen 16. Also, the substrate of adhesive hinge 20 may turn optically clear when light, from display screen 16, passes through the substrate.

Back side 32 of adhesive hinge 20 is bent by crease 36 to make adhesive hinge 20 more flexible. Crease 36 along the major axis of adhesive hinge 20 allows a thicker substrate material to act as a hinge. A thick substrate material can increase hinge strength and stability, but crease 36 can ensure easy movement of display screen filter 18 about adhesive hinge 20. Crease 36 may also allow adhesive hinge 20 to wrap around a large bezel of housing 14. In some embodiments, crease 36 may comprise a score or cut into the substrate of hinge 20.

FIGS. 5A and 5B are schematic diagrams respectively illustrating a back view and a side view of a clasp 22A, which may correspond to clasp 22, described above. Clasp 22A is a single rigid member such as plastic or metal that includes a first portion 40 with a layer of adhesive 44, and an adhesive-free second portion 42. First portion 40 adheres to display screen housing 14 by adhesive layer 44 in such a way that second portion 42 hangs over display screen 16. Second portion 42 holds the second side of display screen filter 18 adjacent to housing 14 without adhering to filter 18. A user operates clasp 22A by bending second portion 42 toward or away from display screen 16 to release or hold filter 18.

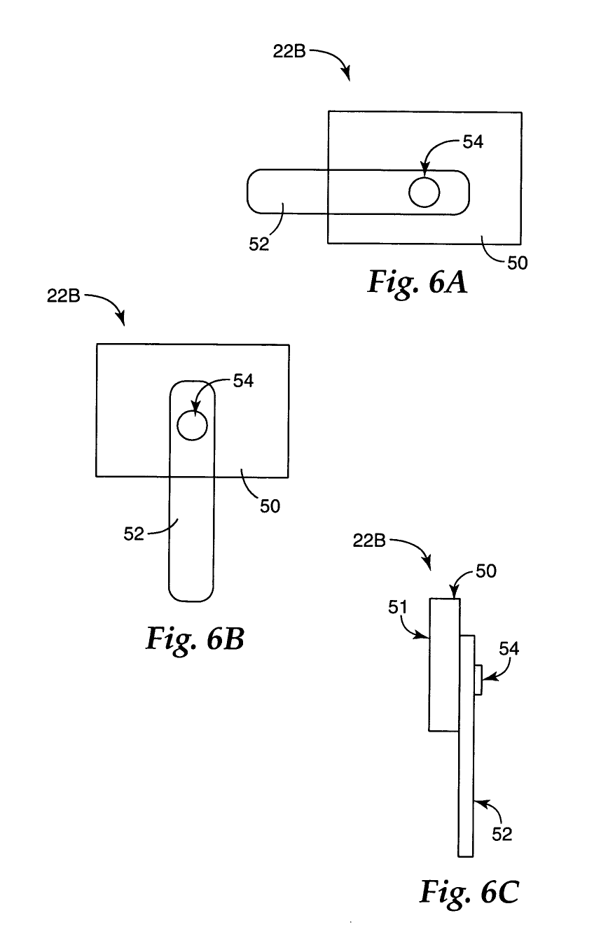

FIGS. 6A, 6B, and 6C are schematic diagrams respectively illustrating two front views and a side view of a clasp 22B, which may correspond to clasp 22 described above. Clasp 22B includes a first member 50 and a second member 52 attached to first member 50 by fastener 54. First member 50 comprises a rigid material such as plastic or metal with a layer of adhesive 51 on one side of first member 50. Second member 52 comprises another piece of a rigid material such as plastic or metal with no adhesive.

Fastener 54 attaches second member 52 to first member 50 in such a way as to allow second member 52 to rotate relative to first member 50 about fastener 54. First member 50 adheres to housing 54 in such a way that second member 52 can hang over display screen 16 to hold the second side of display screen filter 18 without adhering to filter 18. A user rotates second member 52 about fastener 54 to hold or release display screen filter 18. To release filter 18, the user rotates second member 52 to a horizontal position as shown in FIG. 6A. To hold filter 18 adjacent display screen 16 with clasp 22B, the user rotates second member 52 to a vertical position as shown in FIGS. 6B and 6C.

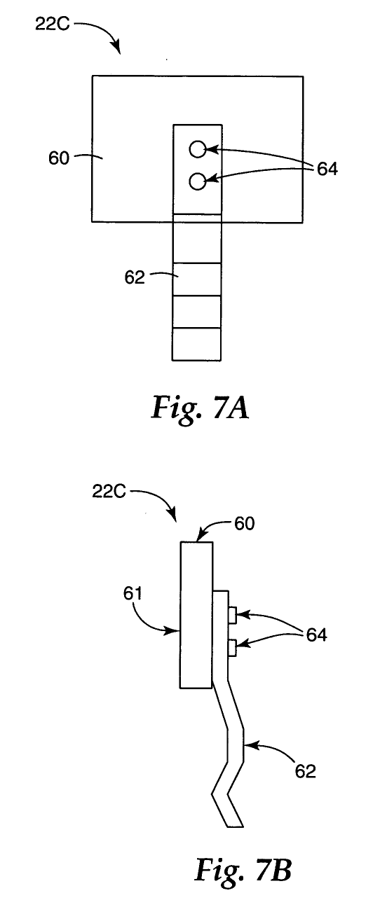

FIGS. 7A and 7B are schematic diagrams respectively illustrating a front view and a side view of a clasp 22C, which may correspond to clasp 22 described above. Clasp 22C includes a first member 60 and a second member 62 attached to first member 60 by fasteners 64. First member 60 comprises a rigid material such as plastic or metal with a layer of adhesive 61 on one side of first member 60. Second member 62 comprises a contoured, memory material such as a plastic or metal that can be distorted from an original shape, but returns to the original shape once released from the distortion. Exemplary memory materials that may be used include any metal, plastic or the like that is sufficiently deflectable, but which returns to its original shape following such deflection.

First member 60 adheres to housing 14 in such a way that second member 62 hangs over display screen 16 and holds the second side of display screen filter 18. A user may release display screen filter 18 by distorting second member 62 from its original shape by pulling second member 62 away from display screen 16. Once the user releases second member 62 it returns to the original shape as seen in FIGS. 7A and 7B.

In another embodiment, a clasp may be molded directly into a housing of a display screen to accommodate the attachment of after-market display screen filter 18 by adhesive hinge 20. In that case, the housing may comprise at least one ridge, lip, hook, or the like to hold display screen filter 18 over display screen 16. Display screen filter 18 may also fit directly into an edge of a bezel of housing 14 that acts as a clasp to hold the second side of filter 18 adjacent housing 14. If the clasp is formed in the housing, a user would attach the filter to the housing using an adhesive hinge, as described herein, along with the clasp formed on the housing of the display screen.

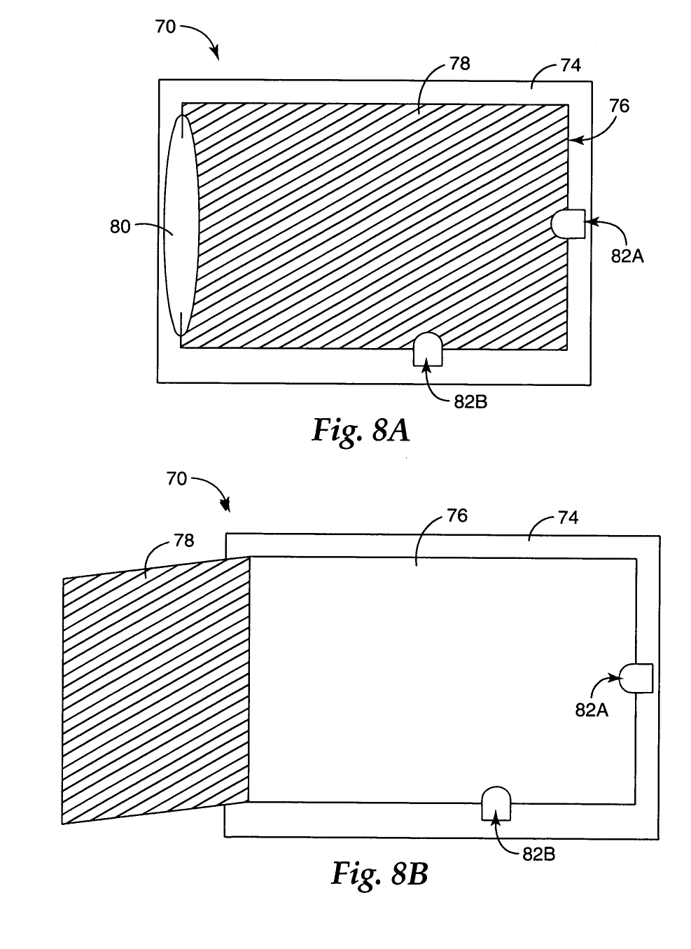

FIGS. 8A and 8B are schematic diagrams illustrating a front view of a mountable display screen system 70. Mountable display screen system 70 includes a display screen filter 78 mounted onto a housing 74 of a display screen 76 by an adhesive hinge 80 and clasps 82A and 82B (hereinafter “clasps 82”). Adhesive hinge 80 attaches a first side of display screen filter 78 to a left edge of housing 74 in a hinged manner. Clasp 82A adheres to a right edge of housing 74 to hold a second side of display screen filter 78 adjacent housing 74. Clasp 82B adheres to a bottom edge of housing 74 to hold a third side of filter 78 adjacent housing 74 and to add support to a bottom edge of filter 78. In further embodiments, additional clasps 82 may hold display screen filter 78 over display screen 76, and adhesive hinge 80 may attach filter 78 to a different edge of housing 74. For example, it may be desirable to provide a clasp on each side of filter 78, other than that adhered by hinge 80, and in some cases, multiple clasps per side may be desirable.

FIG. 8A shows display screen filter 78 held over display screen 76 by clasps 82. FIG. 8B shows display screen filter 78 released from clasps 82 and moved in an arc about adhesive hinge 80. Filter 78 swings away from display screen 76 to allow a user to clean display screen 76 and filter 78, and share information displayed on display screen 76 with several people. In the illustrated embodiment, filter 78 swings to the left of display screen 76, which allows a user to use a keyboard of a computer comprising display screen 76. As shown in FIG. 2B, display screen filter 18 would lie over the keyboard when released from clasp 22 and moved in an arc about adhesive hinge 20, which can make use of the keyboard difficult. The embodiment of FIGS. 8A and 8B alleviate this problem by attaching adhesive hinge 80 to a side of display screen 76.

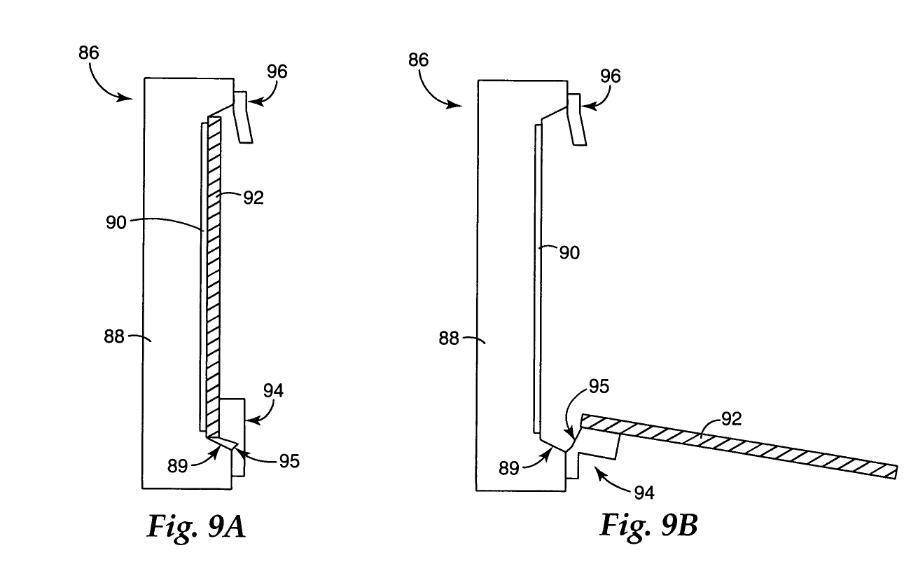

FIGS. 9A and 9B are schematic diagrams illustrating a cross-sectional side view of a mountable display screen system 86. Mountable display screen system 86 includes a display screen filter 92, an adhesive hinge 94, and a clasp 96. Adhesive hinge 94 attaches display screen filter 92 to a housing 88, and clasp 96 holds filter 92 over display screen 90. Housing 88 includes a bezel 89 where housing 88 and display screen 90 meet. To compensate for bezel 89, adhesive hinge 94 includes a score 95 along a major axis.

Adhesive hinge 94 comprises a rigid substrate substantially similar to adhesive hinge 20 described above. The rigid substrate makes it difficult for an adhesive hinge with a crease to securely adhere filter 92 to housing 88 while wrapping around bezel 89. Score 95 allows the first portion of adhesive hinge 94 to adhere to display screen 90, and the second portion to adhere to housing 88 without wrapping adhesive hinge 94 around bezel 89. As illustrated in FIGS. 9A and 9B, adhesive hinge 94 may be thicker on the side that attaches to display screen filter 93 in order to compensate for a gap between display screen 90 and housing 88. In other words, the thickness of a first side of adhesive hinge 94 may be different than a thickness of a second side of adhesive hinge 94.

FIG. 9A shows display screen filter 92 held over display screen 90 by clasp 96. Adhesive hinge 94 aligns filter 92 relative to housing 88 by aligning score 95 with bezel 89 of housing 88. FIG. 9B shows display screen filter 92 released from clasp 96 and moved in an arc about adhesive hinge 94. Adhesive hinge 94 bends along score 95 to allow filter 92 to lean out from display screen 88.

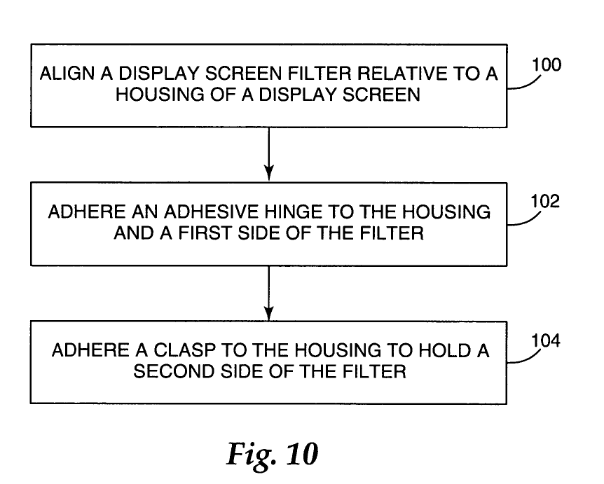

FIG. 10 is a flow diagram illustrating a method for mounting display screen filter 18 over display screen 16. A user aligns display screen filter 18 relative to housing 14 of display screen 16 (100). For example, the display screen 16 may be viewable through an opening in housing 14. The user adheres adhesive hinge 20 to a first side of display screen filter 18 and an edge of housing 14 such that the first side of display screen filter 18 is attached to the housing in a hinged manner (102). The user may use alignment marks 24 printed on adhesive hinge 20 in order to align adhesive hinge 20 with the first side of display screen filter 18 and a bezel of housing 14. Centering adhesive hinge 20 between filter 18 and housing 14 ensures a secure attachment of filter 18 to housing 14.

The user adheres clasp 22 to housing 14 in such a way that a portion of clasp 22 hangs over display screen 16 to hold a second side of display screen filter 18 adjacent housing 14 (104). In other words, the user adheres clasp 22 to housing 14 to hold a second side of display screen filter 18 adjacent housing 14 without adhering clasp 22 to display screen filter 18. The portion of clasp 22 that overhangs display screen 16 includes no adhesive, and does not adhere to display screen filter 18. The user can operate clasp 22 to removably hold filter 18 adjacent display screen. Filter 18 moves off of display screen 16 in an arc about adhesive hinge 20 when released from clasp 22. The user may then replace filter 18 over display screen 16 and operate clasp 22 to again hold filter 18 without substantially weakening the system.

A number of embodiments of a mountable display screen filter system have been described. In particular, systems for attaching after-market display screen filters to a computer display screen have been described. The filter is held adjacent to the housing by an adhesive hinge and a clasp. A user operates the clasp to remove the filter from the display screen by moving the filter in an arc about the adhesive hinge. The system allows the user to attach the display screen filter in an unobtrusive manner and remove the display screen filter from the display screen repeatedly without affecting the integrity of the attachment.

Nevertheless, various modifications may be made without departing from the spirit and scope of this disclosure. For example, the adhesive hinge may comprise a wide variety of materials and shapes. The adhesive hinge may also attach the display screen filter to any edge of the housing preferred by the user. In addition, the clasp may be any structure that holds the display screen filter adjacent the housing without adhering to the filter. These and other embodiments are within the scope of the following claims.

1. A mountable display screen filter system comprising:
a display screen filter;
an adhesive hinge to adhere to a housing of a display screen and a first side of the display screen filter such that the first side of the display screen filter is attached to the housing in a hinged manner; and
a clasp to adhere to the housing and hold a second side of the display screen filter adjacent the housing without adhering to the display screen filter.

2. The mountable display screen filter system of claim 1, further comprising a plurality of clasps.

3. The mountable display screen filter system of claim 1, wherein the clasp removably holds the second side of the display screen filter adjacent the housing such that the display screen filter can be removed from the clasp and moved in an arc about the adhesive hinge.

4. The mountable display screen filter system of claim 1, wherein the clasp comprises a rigid member including an adhesive over a first portion of the member to adhere to the housing and substantially no adhesive over a second portion to hold the second side of the display screen filter adjacent the housing without adhering to the display screen filter.

5. The mountable display screen filter system of claim 1, wherein the clasp comprises a first member including an adhesive to adhere to the housing and a second member to hold the second side of the display screen filter adjacent the housing without adhering to the display screen filter, wherein the second member is attached to the first member.

6. The mountable display screen filter system of claim 5, wherein the second member rotates relative to the first member to hold or release the second side of the display screen filter adjacent the housing.

7. The mountable display screen filter system of claim 1, wherein the clasp comprises a memory material that distorts from an original shape to release the second side of the display screen filter and returns to the original shape to hold the second side of the display screen filter adjacent the housing.

8. The mountable display screen filter system of claim 1, wherein the clasp comprises a pre-molded portion of the housing.

9. The mountable display screen filter system of claim 1, wherein the adhesive hinge comprises a rigid substrate with a layer of adhesive material coated on one side of the substrate.

10. The mountable display screen filter system of claim 9, wherein the rigid substrate comprises a metal.

11. The mountable display screen filter system of claim 9, wherein the rigid substrate comprises a plastic.

12. The mountable display screen filter system of claim 1, wherein the adhesive hinge includes alignment marks near opposing edges of the adhesive hinge for aligning the display screen filter relative to the housing.

13. The mountable display screen filter system of claim 12 wherein the adhesive hinge includes a source identifier.

14. The mountable display screen filter system of claim 1, wherein the adhesive hinge includes a crease substantially along a major axis of the adhesive hinge.

15. The mountable display screen filter system of claim 14, wherein the crease substantially along the major axis of the adhesive hinge corresponds to a bezel of the housing.

16. The mountable display screen filter system of claim 14, wherein the crease comprises a score.

17. The mountable display screen filter system of claim 1, wherein the display screen filter consists of a filter selected from the following group: a privacy filter; a clear protection filter, an anti-glare filter, a polarization filter, a radiation reduction filter, an ultraviolet radiation filter, an anti-reflection filter and a contrast enhancement filter.

18. The mountable display screen filter system of claim 1, wherein the system comprises an after-market addition to a computer display.

19. The mountable display screen filter system of claim 17, wherein the computer display comprises a liquid crystal display (LCD).

20. The mountable display screen filter system of claim 1, wherein the display screen filter comprises a frameless display screen filter.

21. A system comprising:
a computer display including a housing and a display screen viewable through an opening in the housing; and
a display screen filter mounted on the housing over the display screen via an adhesive hinge that adheres to the housing and a first side of the display screen filter such that the first side of the display screen filter is attached to the housing in a hinged manner, and a clasp that adheres to the housing and holds a second side of the display screen filter adjacent the housing without adhering to the display screen filter.

22. The system of claim 21, wherein the clasp removably holds the second side of the display screen filter adjacent the housing such that the display screen filter can be removed from the clasp and moved in an arc about the adhesive hinge.

23. The system of claim 21, wherein the clasp comprises a rigid member including an adhesive over a first portion of the member to adhere to the housing and substantially no adhesive over a second portion to hold the second side of the display screen filter adjacent the housing without adhering to the display screen filter.

24. The system of claim 21, wherein the clasp comprises a first member including an adhesive to adhere to the housing and a second member to hold the second side of the display screen filter adjacent the housing without adhering to the display screen filter, wherein the second member is attached to the first member.

25. The system of claim 24, wherein the second member rotates relative to the first member to hold or release the second side of the display screen filter adjacent the housing.

26. The system of claim 21, wherein the clasp comprises a memory material that distorts from an original shape to release the second side of the display screen filter and returns to the original shape to hold the second side of the display screen filter adjacent the housing.

27. The system of claim 21, wherein the clasp comprises a pre-molded portion of the housing.

28. The system of claim 21, wherein the adhesive hinge comprises a rigid substrate with a layer of adhesive material coated on one side of the substrate.

29. The system of claim 21, wherein the adhesive hinge includes alignment marks near opposing edges of the adhesive hinge for aligning the display screen filter relative to the housing.

30. The system of claim 21, wherein the adhesive hinge includes a crease substantially along a major axis of the adhesive hinge.

31. The system of claim 21, wherein the display screen filter consists of a filter selected from the following group: a privacy filter; a clear protection filter, an anti-glare filter, ultraviolet radiation filter, a polarization filter, a radiation reduction filter, and a contrast enhancement filter.

32. A method comprising:
aligning a display screen filter relative to a computer display, the computer display including a housing and a display screen viewable through an opening in the housing;
adhering an adhesive hinge to the housing and a first side of the display screen filter such that the first side of the display screen filter is attached to the housing in a hinged manner; and
adhering a clasp to the housing to hold a second side of the display screen filter adjacent the housing without adhering the clasp to the display screen filter.

33. The method of claim 32, wherein aligning the display screen filter relative to the computer display comprises aligning the display screen filter relative to the housing with the adhesive hinge, the adhesive including alignment marks near opposing edges of the adhesive hinge.

34. The method of claim 32, wherein the adhesive hinge includes a crease substantially along a major axis of the adhesive hinge, the method further comprising aligning the crease relative to a bezel of the housing.

35. The method of claim 32, wherein adhering the adhesive hinge to the housing and the first side of the display screen filter comprises applying pressure to the adhesive hinge to form an adhesive bond with the housing and the first side of the display screen filter.

36. The method of claim 32, further comprising operating the clasp to removably hold the second side of the display screen filter adjacent to the housing such that the display screen filter can be removed from the clasp and moved in an arc about the adhesive hinge.

37. The method of claim 32, wherein the clasp comprises a rigid member including an adhesive over a first portion of the member to adhere to the housing and substantially no adhesive over a second portion, the method further comprising placing the second side of the display screen filter between the second portion of the clasp and the display screen to hold the display screen filter adjacent to the housing without adhering the clasp to the display screen filter.

38. The method of claim 32 wherein the clasp comprises a first member including an adhesive to adhere to the housing and a second member attached to the first member, the method further comprising placing the second side of the display screen filter between the second member of the clasp and the display screen to hold the display screen filter adjacent to the housing without adhering the clasp to the display screen filter.

39. The method of claim 38, further comprising rotating the second member relative to the first member to hold or release the second side of the display screen filter adjacent the housing.

40. The method of claim 32, wherein the clasp comprises a memory material, the method further comprising distorting the clasp from an original shape to release the second side of the display screen filter and releasing the clasp to return to the original shape and hold the second side of the display screen filter adjacent the housing.

41. A mountable display screen filter system comprising:
a display screen filter; and
an adhesive hinge to adhere to a housing of a display screen and a first side of the display screen filter such that the first side of the display screen filter is attached to the housing in a hinged manner, wherein the adhesive hinge is formed with a crease substantially along a major axis of the adhesive hinge.

42. The mountable display screen filter system of claim 41, wherein the crease substantially along the major axis of the adhesive hinge corresponds to a bezel of the housing.

43. The mountable display screen filter system of claim 41, wherein the crease comprises a score.

44. The mountable display screen filter system of claim 41, wherein the adhesive hinge includes alignment marks near opposing edges of the adhesive hinge for aligning the display screen filter relative to the housing.
